(19) United States
(12) Patent Application Publication
(10) Pub. No.: US 2018/0353992 A1
(43) Pub. Date: Dec. 13, 2018

(54) METHOD FOR PRODUCING STRUCTURED SURFACES AND ARTICLES STRUCTURED IN SUCH A WAY

(71) Applicant: Klebchemie M. G. Becker GmbH & Co. KG, Weingarten/Baden (DE)

(72) Inventors: Klaus BECKER-WEIMANN, Baden Baden (DE); Jens FANDREY, Pforzheim (DE)

(73) Assignee: Klebchemie M. G. Becker GmbH & Co. KG, Weingarten/Baden (DE)

(21) Appl. No.: 15/562,337

(22) PCT Filed: Apr. 26, 2016
(86) PCT No.: PCT/EP2016/059267

§ 371 Date: Sep. 27, 2017

(30) Foreign Application Priority Data
Apr. 30, 2015 (DE) 10 2015 005 495.3

(51) Int. Cl. B05D 3/12; B05D 1/38; B05D 1/42; B05D 7/00; B05D 5/00

(52) U.S. Cl. CPC B05D 3/12; B05D 1/38; B05D 2503/00; B05D 7/52; B05D 5/00; B05D 1/42

(57) ABSTRACT

The present invention relates to a process for the production of structured surfaces via application of a layer made of reactive hotmelt and then embossing of the surface, and also to an article thus produced.

The present invention relates to a process for the production of structured surfaces on a substrate coated by means of a hot-coating process, and also to corresponding products.

An increasingly important constituent of design for flooring elements and for the furniture industry, and for interior design, is realistic imitation of natural materials. The visual appearance of wood-composite panels intended to replace real-wood panels, paneling or boards can by way of example be imitated by using a complicated multicolor print, applied directly or onto a paper web or foil web requiring lamination, in particular resin-impregnated papers. This type of print is usually then protected by applying, and hardening, one or more transparent topcoat layers.

Even if the surface is a realistic imitation of a natural product surface, when this surface is viewed against the light or is touched it is apparent that it is an imitation. The optical reflections arising on viewing against the light, and the haptic properties of the coating surfaces, are contrary to those associated with natural surfaces. Imitation of natural materials, in particular wood, stone or cork, requires imitation not only of optical properties but also of their haptic properties and texture. By way of example, it is possible to use papers which have been structured during their production.

Greater closeness to the optical and haptic properties of a natural material surface can accordingly be achieved only if the surface is structured, ideally in conformity with the printed optical structure: it is known that composite panels which have by way of example been printed or covered with resin-impregnated papers can be structured or textured in such a way that an uppermost unhardened layer of resin or of lacquer is brought into contact with a structure roll, press platens or pressure rolls, where the lacquer or the resin hardens to give a lasting three-dimensional surface structure. The hardening can be achieved by heat or radiation through a transparent female embossing mold, where the female embossing mold is then withdrawn from the substrate with the result that the hardened resin or the hardened lacquer has structuring corresponding to a negative image of the surface structure of the female embossing mold.

A substantially regular embossment can not only imitate natural materials but also improve the soiling behavior of a floorcovering. A uniform embossment, i.e. a regular material of elevations and depressions maintaining a particular distance between valleys and a defined height of the elevations can structure an uppermost surface to enable operation of what is known as the lotus effect. This type of embossment can be achieved by using an embossing roll, where an uppermost surface of a topcoat layer is embossed, or a base layer is embossed and is covered with a topcoat layer.

EP 1 645 339 A1 discloses production of a structured surface on a composite panel printed with a decoration and covered with an in particular transparent topcoat layer, in that before the hardening of the topcoat layer a further lacquer layer is applied which bonds to the smooth, as yet unhardened topcoat layer to give a layer that at least to some extent resembles a single layer. It is possible here, by means of an embossing roll which has a specifically designed roll surface structure and the entire surface of which is covered with lacquer, to apply varying quantities of lacquer to the topcoat layer in accordance with the elevations and depressions of the roll surface. Alternatively, a structured surface can be produced by direct lacquer application by means of digital printing heads, e.g. in accordance with the fundamental method used by an inkjet printer, but the structure achieved here does not have the texture and depth of a mechanically embossed structure. In this process, the pores, i.e. depressions, present in natural materials are simulated via elevations, so that what might be called an inverse natural wood surface structure is produced which is indistinguishable by the human eye, and to the touch, down to an order of magnitude of 100 μm. However, these structures have little depth, in particular at most 5 μm.

The furniture industry and flooring industry impose stringent requirements not only on the optical and haptic effects of surfaces but also on resistance values and strength values, examples being scratch resistance, abrasion resistance or wear resistance, UV resistance, fire resistance and chemicals resistance of surfaces. Compliance can be achieved by applying lacquer systems. However, when this approach is used it is impossible to achieve deep mechanical embossment without high cost. Lacquer systems of this type prove to be excessively hard and excessively brittle after hardening, and the small layer thicknesses prevent deep embossing.

It is an object of the present invention, in order to satisfy the ever-more-stringent requirements of the furniture industry and the flooring industry, to propose a simple process which can produce a deeply structured surface in the course of a wet-lacquering procedure or a hot-coating procedure, and which achieves improved haptic properties and optical properties.

The proposed process of the invention achieves a natural structuring effect which is unlike that achieved by lacquer application, because the latter uses elevations known as “positive pores” to imitate depressions.

In particular, the simplified process can, with just a single application, produce large layer thicknesses and corresponding structure depths which moreover exhibit extremely high abrasion resistance and impact resistance. The embossed surface moreover is not subject to any recovery phenomena: the embossed hot-coating surface retains its shape and exhibits no long-term reversion.

A process for the production of structured surfaces is proposed in the invention, where in a first step a) a layer made of reactive hotmelt based on polyurethane is applied onto at least a portion of a substrate, and this may be followed by application of at least one lacquer layer. In a subsequent step b), a structured surface is produced on the applied layer structure by means of an element with a textured surface. Alternatively or additionally it is also possible to apply a lacquer layer after the actual embossing step, and it is also possible here to apply different lacquers before and after the embossing step.

In one embodiment, a lacquer layer is applied to a layer made of reactive hotmelt based on polyurethane, said lacquer being by way of example a UV-curing lacquer. In the invention, the UV lacquer is not fully cured before the subsequent step, but instead undergoes only partial reaction, where the lacquer assumes a gelled consistency. A degree of flexibility is thus retained which facilitates embossing.

The process of the invention for the production of structured surfaces on a substrate accordingly comprises the following steps:
a) Application of a layer made of reactive hotmelt based on a polyurethane onto at least a portion of a surface of the substrate;
b) embossing the surface of the layer applied in a preceding step with an embossing mold which comprises a negative of a three-dimensional structure to be produced on the substrate.

The sequence here can moreover comprise a step c) in which a lacquer layer is applied on the substrate covered with the reactive hotmelt, where the step c) here can take place after step a) and before step b) and/or after step b). It is preferable that step c) follows step b).

Another aspect of the present invention relates to an article with a structured surface on at least a portion of a substrate which is obtainable by the process of the invention.

Surprisingly, the haptic properties of products of this type after final crosslinking are soft and velvet-type and very attractive; the expression “soft touch” is also used to describe these properties.

In the interests of simplicity, the features and preferred features set out below are explained in the context of the process of the invention, but they are equally applicable to the article of the invention.

In one embodiment, a hot-coating layer made of a reactive hotmelt is first provided, and in an appropriate step a surface thereof is embossed with a three-dimensional structure. The reactive hotmelt is a reactive hotmelt based on polyurethane; reaction and hardening of said hotmelt is normally achieved with the aid of moisture present in the ambient air. However, hotmelts which are based on polyurethane and are curable by radiation or which react when irradiated are also suitable; a suitable hotmelt based on a moisture-crosslinking polyurethane here comprises a component which can be polymerized by an electron beam or by UV radiation, a photoinitiator, and also optionally additional substances.

Accordingly, a preferred process of the invention has the following feature: the reactive hotmelt based on a polyurethane in step a) is a radiation-curable hotmelt which comprises at least one functional group polymerizable by irradiation.

Suitable reactive hotmelts which can be cured by irradiation are described for example in U.S. Pat. No. 8,153,264 B2 or WO 2006/106143 A1.

The polyurethane-based reactive hotmelt may be either a one-component or a multi-component, especially a two-component. A one-component reactive hotmelt is preferred.

The one-component polyurethane-based reactive hotmelt is in the prior art, as for example in WO 2006/056472 A1 or WO 2012/084823 A1.

When a two-component hotmelt is used, it is preferable that one of the components comprises a mixture of one or more polyols, and also optionally additives, and that the other component comprises one or more polyisocyanates, and also optionally additives. The two components here are mixed by using two-component mixing and metering systems of the type known from the prior art. The two components are generally mixed directly before use of the reactive hotmelt.

The layer system described above can in particular comprise further layers which by way of example facilitate bonding of the layer system to the substrate.

A reactive hotmelt based on polyurethane features good adhesion properties on a very wide variety of substrates: substrates can be composed, at least in part, of wood, wood-like material, iron, nonferrous metal, plastic, decorative or other paper, paperboard, papier mache, glass, linoleum, or inorganic non-metalliferous or mineral substances. It is preferable that the substrate is the surface of a wood-composite panel, inorganically bonded panel, plastics panel, compact panel, sandwich panel or lightweight panel and/or of linoleum.

The reactive hotmelt based on polyurethane can, in one embodiment, be applied to a substrate, for example made of paper, provided in the form of web or in the form of sheet. This substrate thus covered can be structured by means of an embossing step before or during or after lamination of said layer structure on a further supportive substrate or supportive panel. Accordingly, an overlay or a lamination material or sheathing material is provided which can be laminated to a supportive substrate or to a supportive panel.

Alternatively, a substrate to be coated is provided and has, applied by printing thereon, an optical depiction of a surface to be replicated, for example a depiction of a wood surface. The print can be applied directly to the substrate so that it is substantially a constituent of the substrate surface. Alternatively, the substrate can be covered with a web material, for example made of paper or foil printed with an appropriate decoration. A layer made of colored hot-coating can moreover be produced on the substrate; this can also be used in the form of web material. There are known printing processes where a multicolor image is produced on a substrate by means of a microprocessor-controlled inkjet printer with stationary or single-pass or movable or multi-pass print heads. The substrate can in particular have been pretreated with a sealing layer and can be covered with protective layers after printing.

Accordingly, a preferred embodiment provides a process in which before the application of the reactive hotmelt in step a), a decoration, for example taking the form of a web material provided with a decoration, is applied to the substrate. The decoration here can be applied to at least a portion of the surface of the substrate by direct or digital printing. It is preferable that the three-dimensional structure produced by embossing in step b) is synchronized with the applied decoration.

Another preferred embodiment comprises a process of the invention in which, before the application of the reactive hotmelt in step a), a colored hot-coating layer is applied to the substrate.

A reactive hotmelt which is based on polyurethane and which is applied in the context of the hot-coating system to a substrate thus printed has the advantage that a single application can also achieve large layer thicknesses. Layer thicknesses in the range from 50 μm to 800 μm can be achieved. The layer thickness is preferably from 50 μm to 300 μm, more preferably from 50 μm to 200 μm. A single application can produce layer thicknesses varying over a wide range, and this represents an advantageous time saving, contrasting with conventional lacquer coatings applied in a plurality of layers with appropriate intervening polishing and drying steps. By using a wide range of possible layer thicknesses it is possible to produce products for various usage categories, for example usage category 21 (residential/moderate) to usage category 33 (commercial/high) for flooring elements in accordance with DIN EN 13329 (January 2009).

The reactive hotmelt based on polyurethane is an emission- and solvent-free product that is solid at room temperature. The temperature at which the reactive hotmelt is applied is in the range from 60° C. to 150° C., preferably from 100° C. to 140° C., and the BROOKFIELD viscosity of the product at 120° C. is in the range from 1000 mPas to 30 000 mPas, preferably from 4000 mPas to 10 000 mPas. The density of the reactive hotmelt is usually 1.1 g/m². The layer made of reactive hotmelt based on polyurethane can by way of example be applied by doctoring, rolling, or spraying, or by means of nozzles or slot dies, or by means of curtain-coating or by application of thin strands. The quantity of reactive hotmelt that can be applied here per square meter of surface to be coated is about 20 g to 1200 g, preferably 20 g to 450 g, more preferably 20 g to 300 g. It is advantageous that the layer of reactive hotmelt has a degree of residual elasticity, even after it has been hardened. It is preferable that hardening is achieved not only by physical solidification but at least to some extent—in particular exclusively—by moisture-curing with the aid of atmospheric moisture.

In order to achieve appropriate demanded resistance values, the reactive hotmelt can comprise additives, auxiliaries and/or fillers, and particles of a filler component here can vary within a wide range in respect of material, particle size, particle shape and particle weight. By virtue of the good binding of the particles of the filler component into the reactive hotmelt with high viscosity and specific rheology, distribution of the particles remains substantially uniform even at a relatively high processing temperature, and there is therefore no need for any additional mixing.

The layer of reactive hotmelt can, before it has hardened completely, be covered with a lacquer layer, which provides protection and at the same time provides a surface effect. In particular, the lacquer can be applied before the actual embossing step, after the embossing step or both before and after the embossing step. There is no requirement here for complete hardening of the applied reactive hotmelt based on polyurethane and, where appropriate, of the applied lacquer layer. The lacquer(s) used can be any desired lacquer; the lacquer is advantageously characterized by a short hardening time. Two-component PUR lacquers, nitrolacquers and aqueous lacquers are mentioned by way of example. It is preferable to use UV-curing lacquers. A conventional application process can be used to apply the lacquer, the thickness of a lacquer layer here being from 5 μm to 25 μm.

In particular, a combined layer of reactive hotmelt/lacquer combines the advantageous properties of the individual layers: the reactive hotmelt can harden even when the lacquer layer applied prevents direct contact of the layer of reactive hotmelt with the ambient air.

An improvement can be achieved in that, after application of the reactive hotmelt to the substrate, the layer is smoothed, advantageously with heat provided by way of example by means of a smoothing roll or smoothing belt. An appropriate smoothing step is disclosed by way of example in WO 2006/066954 A1.

Accordingly, it is preferable that, in the process of the invention following step a), a step is provided in which the layer applied to the substrate and made of reactive hotmelt based on a polyurethane is smoothed.

Production of a structured surface, also termed embossment, is facilitated by the hot-coating system in that it is also possible to achieve an applied layer system with large layer thickness, in particular because the hardening procedure based on moisture-crosslinking is non-limiting. The layer thickness is directly related to the profile depth of the embossment structure. The process of the invention therefore provides the possibility, via large layer thickness, of producing a structure of significant depth, even when the substrate itself is not concomitantly embossed. The invention permits application of layer thicknesses of from 50 to 200 μm and—as stated above—even larger thicknesses. In one embodiment, the embossment can also comprise embossing of the substrate provided, in particular when the substrate is composed at least to some extent of cork.

The known processes for the production of structured surfaces by means of a topcoat lacquer layer and of a lacquer structure applied thereto or produced, with involvement of a further lacquer layer, are unlike the process of the invention, which advantageously uses the properties of the hot-coating system. The reactive hotmelt based on polyurethane cures by chemical crosslinking by the moisture present in the environment, and a lacquer layer applied here, and therefore covering the material, does not prevent hardening. A combined layer system can easily be embossed, and embossing here can take place either in-line or at a subsequent juncture, or off-line. Embossing can by way of example be achieved by using an embossing roll or calender roll which has a surface structure, where a negative image of the surface structure of the embossing roll is produced on the uppermost surface of the coated substrate. It is possible to use not only rolls made of metal but also rubberized rolls which have depressions introduced into their rubberized surface. A roll surface composed of rubber or of a rubber-like material can moreover compensate uneven areas of the surface to be structured. It is moreover also possible to use embossing rolls made of plastic, wood or textile.

Accordingly, an embossing mold which takes the form of embossing roll and which is composed of a material selected from metal, plastic, wood, rubber and textile is preferably used for the embossing in step b).

Alternatively, a short-cycle press with an embossing mold in the form of a press platen or of a continuous belt, also known as structured transfer film, can be used to produce the production of the embossed surface structure. The conventional method uses metallic embossing molds where a metal sheet pretreated by printing with a mask is etched in a manner that etches the regions not covered by the mask. Production of a deep structure requires a plurality of operations. Another known method, alongside metallic embossing molds, uses PET foils as female embossing molds, and material is to some extent ablated here in the form of etched depressions. Suitable embossing molds or press molds have a roughness depth of up to 1000 μm. Embossing molds can take the form of female molds made of metal, plastic, wood, rubber, stone or textile.

Accordingly, the embossing in step b) can be achieved with an embossing mold in the form of embossing roll, or with a flat embossing mold. A structured transfer film, in particular made of metal, plastic or textile, can likewise be used as the embossing mold.

The process of the invention for the production of structured surfaces on a substrate coated by means of a hot-coating process comprises the actual embossing of the uppermost surface after application of a layer of reactive hotmelt and possibly of a lacquer layer. It is also possible moreover to provide further layers in order to produce a layer system where the thickness the layer to be embossed increases and accordingly greater profile depths are achieved. Some parameters for the embossing step can be varied: the embossment depth to be achieved in the resultant surface structure is a function of the period between application of the reactive hotmelt and the possible lacquer layer and the embossing step; this period can also be termed crystallization time or hardening time. As the degree of crosslinking of the applied reactive hotmelt increases, i.e. as the extent to which hardening has proceeded increases, the temperature and pressure to be selected for the embossing step increase, or the resultant three-dimensional structure becomes flatter and less sharp.

The embossing in step b) can in principle take place immediately, without delay. However, there is usually a delay of from 20 seconds to 72 hours.

The required crystallization time or hardening time in an in-line process is preferably from 30 s to 4 h. If permitted by the properties of the substrate to be coated and by the hot-coating system used, it is possible to extend the crystallization time or hardening time as far as 24 h or 72 h while achieving ideal embossing results; the applied coating system here hardens before, during and/or after the embossing step. In particular, it is advantageous that it is also possible to use a short crystallization time or hardening time before the embossing step without loss of sharpness and/or depth caused by recovery effects in the resultant three-dimensional surface structure.

The three-dimensional structure produced by embossing in step b) can extend only into the layer(s) applied to the substrate, or can extend into the substrate.

The temperature prevailing during the embossing procedure is moreover important. A temperature range from 20° C. to 180° C. is preferred. If the temperature is too high, color changes can occur in the layer(s) applied. A factor that has to be considered here is that certain materials of the embossing mold have insulating effect, and the temperature on the surface to be structured therefore differs from that of the embossing mold. It is preferable here that the embossing mold is a heated mold.

Accordingly, the embossing in step b) is preferably achieved at a temperature in the range from 20° C. to 180° C., where the embossing mold is a heated mold.

Another parameter of the embossing procedure is the pressure applied and the time for which pressure is applied. The pressure applied in the invention can, if permitted by the embossing mold or press mold, be from 30 bar to 150 bar, the time for which pressure is applied being from 5 seconds to 20 seconds.

A particular advantage of the process of the invention for the production of structured surfaces on a substrate coated by means of a hot-coating process consists in time-saving production, at reduced cost, of structures which are identical with those known in nature and which have particularly attractive optical and haptic properties. The process moreover provides the possibility of complying with the stringent requirements placed upon resistance values for a variety of applications extending from furniture parts to flooring elements. In particular, the physical and chemical properties of the reactive hotmelt based on polyurethane with combined lacquer application in the context of hot-coating prove to be advantageous with respect to embossing, because in essence no recovery effects are expected to occur. The surface structures achieved by embossing are retained in the form in which they are present directly after embossing. It is thus possible to achieve realistic replication of the appearance of natural materials, where this extends as far as: warm and natural haptic properties, flexibility, and gloss rating <10 GU (gloss units) at 60° in accordance with DIN EN 13722 (October 2014).

Other advantages and embodiments of the subject matter of the invention are illustrated by the drawings and explained in more detail in the description below.

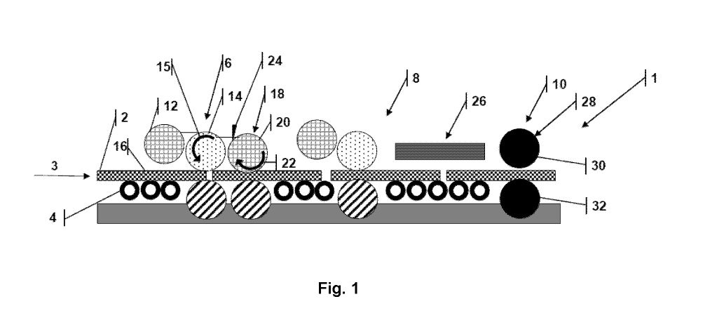

FIG. 1 shows a device or system for the production of products in the form of panels with a surface having a decoration and structuring.

FIG. 1 depicts a device 1 or system for the production of products in the form of panels with a decoration, for example furniture-construction panels, flooring elements, wall panels or ceiling panels.

A plurality of substrates 2, depicted as products in the forms of panels in FIG. 1, are arranged on a transport device 4 and are introduced in succession to various operating units 6, 8, 10. The transport device 4 can take the form of roller conveyor with conveying rollers. An arrow 3 indicates the transport direction of the substrate 2. It is also possible to carry out operations on a single substrate 2 of large surface area or on a continuously produced workpiece, these being divided into individual products at a subsequent juncture.

The expression supportive substrate can also be used for the substrate 2. The substrate 2 can be wood-based, an example being particle board, medium-density fiberboard, high-density fiberboard or hardboard, or cork. The following are moreover suitable: inorganically bonded panels (e.g. gypsum, gypsum fiber, cement), plastic (e.g. PVC, acrylic, PP, etc.), compact panels (e.g. resin-impregnated papers), sandwich structures, lightweight panels (e.g. a honeycomb core with appropriate outer plies) and/or linoleum.

After possible pretreatment, e.g. for the cleaning of the surface, the substrate 2 can be printed, for example digitally, with a decoration in an operating unit (not depicted). Alternatively, a foil provided with a decoration, or a paper, can be laminated to the substrate 2. The decoration, for example a decorative wood effect, decorative natural stone effect or other decoration, can be applied by printing by means of one or more print-roll systems or a digital printing device, and this can be followed by devices for downstream operations, for example for the drying or partial drying of the printed decorative image.

In a subsequent operating unit 6, for which the expression applicator unit is also used, the substrate 2 thus covered or printed, which possibly has been preheated, is covered, by means of a hot-coating process, with a reactive hotmelt based on polyurethane. FIG. 1 indicates that the reactive hotmelt is applied by means of a pair of rolls 12, 14; the application weight and the layer thickness can be varied here. The applicator unit 6 comprises a metering roll 12 which is in contact with an applicator roll 14; the reactive hotmelt (not depicted) is located therebetween. The applicator roll 14 rotates in a direction indicated by arrow 15. Reactive hotmelt is applied in a defined layer thickness by the applicator roll 14 to a surface 16 of the substrate 2. The reactive hotmelt is heated and is used in the form of a viscous liquid; heating can be provided here by means of the metering roll 12. In the exemplary embodiment depicted in FIG. 1, the applicator unit 6 is followed immediately by a smoothing unit 18 for the smoothing of the applied reactive hotmelt, where a smoothing roll 20 present rotates in a direction, indicated by arrow 22, opposite to the direction of transport 3 of the substrate 2. The smoothing roll 20 is arranged after, and very close to, the applicator roll 14, or is in contact with same. The smoothing roll 20 is in contact with the substrate 2 by way of that region of the surface 16 that is covered by the reactive hotmelt. 24 denotes doctor equipment arranged on the smoothing roll 20 so that it can remove reactive hotmelt adhering on the smoothing roll 20. Other embodiments of the smoothing unit 18 are conceivable, e.g. introduction of heat or the use of a smoothing belt instead of a smoothing roll 20.

After the smoothing unit 18, the substrate 2 thus covered passes through an operating unit 8 in which lacquer is applied, preferably in what is known as a wet-on-wet process. Because, surprisingly, there is no requirement for complete hardening of the applied layer of reactive hotmelt, the lacquer can be applied immediately, in particular before complete hardening of the layer of reactive hotmelt. The lacquer used can be any desired lacquer, preferably a UV-curing lacquer. The operating unit 8 is designed by way of example for roll application, as indicated in FIG. 1, for spray application or for a curtain-coating process. A hardening procedure that follows can by way of example be achieved by means of a device 26 where UV light or UV lamps can be used.

In a further operating unit 10 into which the substrate 2 is conveyed either immediately or after a short quiescent phase, i.e. in-line, or after a more extended quiescent phase, i.e. off-line, the substrate 2 thus coated is embossed with an embossing mold 28 in order to produce a three-dimensional structure of the surface. FIG. 1 indicates that the operating unit 10, also termed embossing unit, comprises an embossing mold 28 in the form of a pair of rolls with a pressure cylinder and a counterpressure cylinder 30, 32. The pressure cylinder 30 has a covering with elevations and depressions on its surface, and as said cylinder rotates these become impressed in negative form on the surface of the substrate 2 thus coated. The nature of the elevations and depressions, both in terms of their distribution and also in terms of their depth and shape, is such that natural haptic properties are replicated. Alternatively, a short-cycle press can be used to achieve the embossment by means of an embossing mold 28 in the form of a press platen. The embossing mold 28 here can be heated by appropriate heating equipment; the hardening of the previously applied layers is advantageously achieved here in conjunction with increased adhesion.

### LIST OF REFERENCE SIGNS

1 Device
2 Substrate
3 Direction of transport
4 Direction of transport
6 Operating/applicator unit
8 Operating unit
10 Operating/embossing unit
12 Metering roll
14 Applicator roll
15 Direction of rotation of applicator roll
16 Surface
18 Smoothing unit
20 Smoothing roll
22 Direction of rotation of smoothing roll
24 Doctor equipment
26 Hardening device
28 Embossing mold
30 Pressure cylinder
32 Counterpressure cylinder

1.-18. (canceled)

19. A process for the production of structured surfaces on a substrate (2), where the steps comprise:
a) Application of a layer made of moisture-crosslinking reactive hotmelt based on a polyurethane onto at least a portion of a surface (16) of the substrate (2);
b) Use, for embossing of the surface of the layer applied in a preceding step, of an embossing mold (28) which comprises a negative of a three-dimensional structure to be produced on the substrate (2); and a step
c) where a lacquer layer is applied to the substrate (2) covered with reactive hotmelt and where the lacquer layer is applied after step a) and before embossing step b) or both, before and after embossing step b).

20. The process as claimed in claim 19, characterized in that the reactive hotmelt based on a polyurethane in step a) is a radiation-curable hotmelt comprising at least one functional group polymerizable by irradiation.

21. The process as claimed in claim 19, characterized in that, following step a), a step is provided in which the layer applied to the substrate (2) and made of reactive hotmelt based on a polyurethane is smoothed.

22. The process as claimed in claim 19, characterized in that the embossing in step b) takes place immediately with no delay.

23. The process as claimed in claim 19, characterized in that the embossing in step b) takes place after a delay in the range from 20 seconds to 72 h.

24. The process as claimed in claim 19, characterized in that an embossing mold (28) in the form of embossing roll, or a flat embossing mold (28) is used for the embossing in step b).

25. The process as claimed in claim 19, characterized in that the embossing in step b) takes place at a temperature in the range from 20° C. to 180° C., where the embossing mold (28) has been heated.

26. The process as claimed in claim 19, characterized in that an embossing mold (28) which takes the form of female mold and which is made of a material selected from metal, plastic, wood, rubber, stone and textile is used for the embossing in step b).

27. The process as claimed in claim 19, characterized in that an embossing mold (28) which takes the form of embossing roll and which is made of a material selected from metal, plastic, wood, rubber and textile is used for the embossing in step b).

28. The process as claimed in claim 19, characterized in that an embossing mold (28) which takes the form of structured transfer film and is made of a material selected from metal, plastic and textile is used for the embossing in step b).

29. The process as claimed in claim 19, characterized in that, before the application of the reactive hotmelt in step a), a decoration is applied to the substrate (2), where the decoration has been applied to at least a portion of the surface (16) of the substrate (2) by direct or digital printing.

30. The process as claimed in claim 19, characterized in that, before the application of the reactive hotmelt in step a), a web material provided with a decoration has been applied to the substrate (2).

31. The process as claimed in claim 19, characterized in that, before the application of the reactive hotmelt in step a), a colored hot-coating layer has been applied to the substrate (2).

32. The process as claimed in claim 19, characterized in that the three-dimensional structure produced by embossing in step b) has been synchronized with the applied decoration.

33. The process as claimed in claim 19, characterized in that the substrate (2) is a wood-composite panel, inorganically bonded panel, plastics panel, compact panel, sandwich panel or lightweight panel and/or linoleum.

34. The process as claimed in claim 19, characterized in that the three-dimensional structure produced by embossing in step b) extends within the layers applied to the substrate (2).

35. The process as claimed in claim 19, characterized in that the three-dimensional structure produced by embossing in step b) extends into the substrate (2).

36. The process as claimed in claim 19, characterized in that the reactive hotmelt is a single-component.
